(19) United States
(12) Patent Application Publication
(10) Pub. No.: US 2013/0153780 A1
(43) Pub. Date: Jun. 20, 2013

(54) DIGITAL X-RAY DETECTOR

(71) Applicants: Sang-Il Lee, Yongin-si (KR); Jeong-Pil Lee, Bucheon-si (KR); Won-Zoon Lee, Seongnam-si (KR); Beom-Jin Moon, Suwon-si (KR); Jung-Kee Yoon, Anyang-si (KR)

(72) Inventors: Sang-Il Lee, Yongin-si (KR); Jeong-Pil Lee, Bucheon-si (KR); Won-Zoon Lee, Seongnam-si (KR); Beom-Jin Moon, Suwon-si (KR); Jung-Kee Yoon, Anyang-si (KR)

(73) Assignee: DRTECH CORPORATION, Seongnam-si (KR)

(21) Appl. No.: 13/818,030

(22) PCT Filed: Oct. 7, 2010
(86) PCT No.: PCT/KR2010/006857

§ 371 Date: Feb. 20, 2013

(30) Foreign Application Priority Data
Aug. 24, 2010 (KR) 10-2010-0082163

(51) Int. Cl. G01T 1/16

(52) U.S. Cl. CPC G01T 1/16
USPC 250/394

(57) ABSTRACT

A digital X-ray detector is provided, and the digital X-ray detector includes an X-ray detection array configured to detect an X-ray image when a subject is irradiated with X-ray; a support board configured to support a lower part of the X-ray detection array and have a bottom surface thereon a plurality of spaced-apart first joining portions are formed; an external case configured to accommodate the X-ray detection array and the support board and have an inner bottom surface thereon a plurality of second joining portions are formed to correspond to the plurality of first joining portions; and shock absorption members configured to be vertically arranged between the bottom surface of the support board and the inner bottom surface of the external case, each shock absorption member having an upper end to be coupled to the first joining portion and a lower end to be coupled to the second joining portion.

### CROSS-REFERENCE TO RELATED APPLICATION

This application claims the benefit under 35 U.S.C. §119(a) of Korean Patent Application No. 10-2010-0082163, filed on Aug. 24, 2010, the entire disclosure of which is incorporated herein by reference for all purposes.

### BACKGROUND

1. Field

The following description relates to a digital X-ray detector for obtaining a digital image using a Thin Film Transistor (TFT) without a film.

2. Description of the Related Art

A conventional X-ray image photographing system is used in a medical industry to photograph a subject onto a film and, and the resulting film needs to be printed for diagnosis. However, many research and studies have been conducted recently to develop a digital X-ray detector for obtaining a digital image using a TFT without a film.

For example, a digital X-ray detector may have an X-ray detection array which is fixed onto an external case thereof. At this time, the X-ray detection array includes a glass substrate, a TFT laminated on the glass substrate, a light converting material layer of amorphous selenium laminated on the TFT, an insulating layer formed on the light converting material layer and top electrodes formed on the insulating layer.

When the X-ray detection array is irradiated with X-rays, the X-ray produces electron-hole pairs in the light converting material layer. The electron-hole pairs are accelerated by power which is applied to top electrodes, so that the electrons may be transferred to external electrodes and the holes may be charged in a capacity of the TFT via upper electrodes of the TFT. Then, the TFT is switched on and off, an X-ray detection image may be obtained.

However, the above-mentioned digital X-ray detector are highly likely to be exposed to external forces since the X-ray image photographing system is often used outside. For example, while being moved or used, the digital X-ray detector may fall over or an external force may be imposed thereon.

In such cases, elements of the digital X-ray detector, such as a light converting material layer, a TFT and a glass substrate, may be damaged, thereby affecting performance of the digital X-ray detector. For this reason, it is required to come up with a measure to protect the X-ray detection array from a shock.

### SUMMARY

In order to solve the above drawbacks, the present invention provides a digital X-ray detector for protecting fragile elements therein.

In one general aspect of the present invention, a digital X-ray detector is provided, and the digital X-ray detector includes an X-ray detection array configured to detect an X-ray image when a subject is irradiated with X-ray; a support board configured to support a lower part of the X-ray detection array and have a bottom surface thereon a plurality of spaced-apart first joining portions are formed; an external case configured to accommodate the X-ray detection array and the support board and have an inner bottom surface thereon a plurality of second joining portions are formed to correspond to the plurality of first joining portions; and shock absorption members configured to be vertically arranged between the bottom surface of the support board and the inner bottom surface of the external case, each shock absorption member having an upper end to be coupled to the first joining portion and a lower end to be coupled to the second joining portion.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional diagram illustrating a digital X-ray detector according to an exemplary embodiment of the present invention;

FIG. 2 is an exploded oblique view illustrating how shock absorption members are inserted into a support board and an external case with respect to FIG. 1;

FIG. 3 is a cross-sectional view illustrating variations of a first joining portion and a second joining portion of FIG. 1;

FIG. 4 is an exploded oblique view illustrating how the shock absorption members are inserted into the first joining portion and the second joining portion with respect to FIG. 3;

FIG. 5 is an exploded oblique view illustrating variations of a first groove, a second groove and the shock absorption member with respect to FIG. 2; and

FIG. 6 is an exploded oblique view illustrating a variation of the shock absorption member with respect to FIG. 2.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

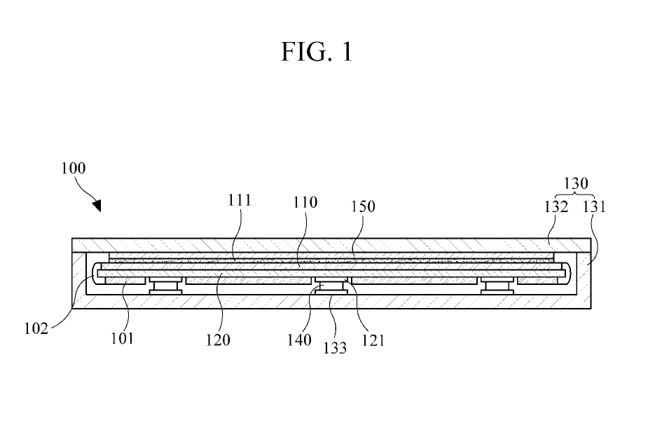

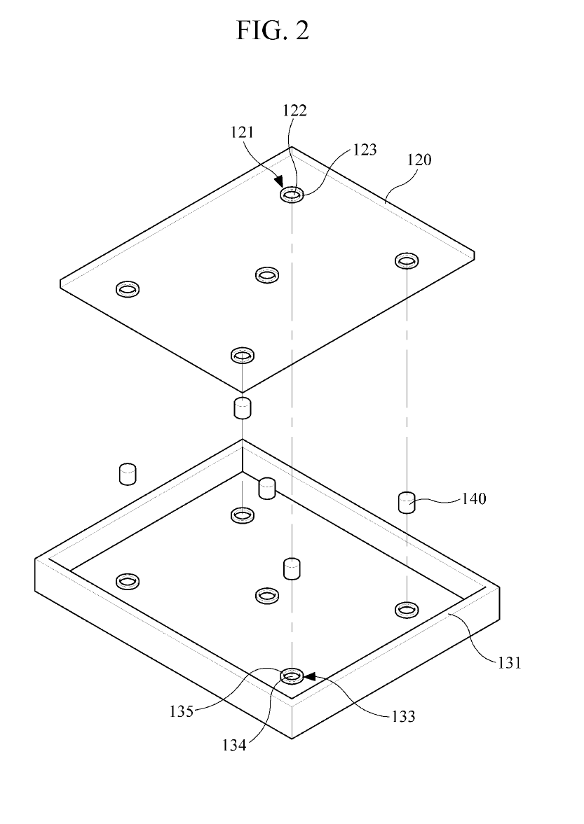

FIG. 1 is a cross-sectional view illustrating a digital X-ray detector according to an exemplary embodiment of the present invention. In addition, FIG. 2 is an exploded oblique view illustrating how shock absorption members are inserted into a support board and an external case.

Referring to FIGS. 1 and 2, the digital X-ray detector 100 includes an X-ray detection array 110, the support board 120, the external case 130 and the shock absorption members 140.

The X-ray detection array 110 detects an X-ray image when a subject is irradiated with X-rays. Here, the X-ray detection array 110 may convert the X-rays directly into electric charge. For example, the X-ray detection array 110 includes a glass substrate, a Thin Film Transistor (TFT) laminated on the substrate, a light converting material layer 111 of amorphous selenium laminated on the TFT, an insulating layer formed on the light converting material layer 111, and top electrodes formed on the insulating layer.

If a top surface of the X-ray detection array 110 is irradiated with X-ray, the light converting material layer 111 is ionized to thereby produce electron-hole pairs. The electron-hole pairs are accelerated by power applied to the top electrodes, so that electrons may be transferred to external electrodes and the holes may be charged in a capacitor of the TFT via the upper electrons of the TFT. Then, the TFT is switched on and off, an X-ray detection image may be obtained.

The X-ray detection array 110 is deposited on the top surface of the support board 120, so that the support board 120 supports the lower part of the X-ray detection array 110. In addition, a circuit board 101 may be mounted to the bottom surface of the support board 120, and may be electrically connected to the X-ray detection array 110 through connecting members 102. On the bottom surface of the support board 120, a plurality of spaced-apart first joining portions 121 may be formed. The first joining portions 121 are respectively coupled to the upper ends of the shock absorption members 140.

The external case 130 accommodates the X-ray detection array 110 and the support board 120. The external case 130 surrounds the X-ray detection array 110 for protection, and may be made of carbon and etc. so as to reduce an external shock. The external case 130 may consist of a cabinet 131 and a cover 132.

The upper part of the cabinet 131 is open, so the cabinet 131 consists of a flat bottom surface and four sidewalls. The cover 132 covers the opening of the cabinet 131. When covering the opening of the cabinet 131, the cover 132 is fixed to the cabinet 131. The second joining portions 133 are formed on the inner bottom surface of the external case 130, that is, an inner bottom surface of the cabinet 131, to correspond to the first joining portions 121. The second joining portions 133 are respectively coupled to the lower ends of the shock absorption members 140.

The shock absorption members 140 are vertically arranged between the bottom surface of the substrate board 120 and the inner bottom surface of the external case 130. In addition, each shock absorption member 140 has an upper end to be coupled to the first joining portion 121 and a lower end to be coupled to the second joining portion 133. If an external force is imposed on the digital X-ray detector 100 or if the digital X-ray detector 100 falls over, the shock absorption member 140 may be twisted in an up-and-down direction or in a left-and- right direction to thereby absorb the shock. In this manner, the shock imposed on the X-ray detection array 110 may be reduced.

In addition, each of the shock absorption members 140 has an upper end to be coupled to the support board 120 and a lower end to be coupled to the external case 130, so that the support board 120 may be fixed to the external case 130. Each of the shock absorption members 140 may be made of rubber and the like. The rubber may have a specific hardness not only to absorb an external shock, but also to fix the support board 120 so as to protect a sidewall of the X-ray detection array 110 from being collided with a sidewall of the external case 130.

With regard to the digital X-ray detector 100 configured as described above, the support board 120 may be fixed onto the external case 130 as the shock absorption members 140 are coupled to the support board 120 and the external case 130 without the need of screws or locking devices. Furthermore, the shock absorption members 140 absorb an external shock, so that fragile elements of the X-ray detection array 110, for example, the light converting material layer 111, the TFT and a glass substrate, may be prevented from damage.

Meanwhile, as illustrated in FIG. 1, a buffer 150 may be inserted between the top surface of the X-ray detection array 110 and the inner top surface of the external case 130. The buffer 150 absorbs a shock between the X-ray detection array 110 and the external case 130 to thereby protect the top surface of the X-ray detection array 110. The buffer 150 may be made of sponge, rubber and the like. In this case, the buffer 150 may also insulate the X-ray detection array 110 from the outside.

A compressed buffer 150 may be inserted between the top surface of the X-ray detection array 110 and the inner top surface of the external case 130, thereby pressing the X-ray detection array 110. Accordingly, due to the pressure of the buffer 150 on the X-ray detection array 110 and the supporting force of the shock absorption members 140 to the support board 120, the support board 120 is able to be more stably fixed onto the external case 130.

Meanwhile, the first joining portion 121 may include a first groove 122 which the upper end of the shock absorption member 140 is inserted into, and the second joining portion 133 may include a second groove 134 which the lower end of the shock absorption member 140 is inserted into. As the upper end and the lower end of each shock absorption member 140 are inserted into the first groove 122 and the second groove 134, respectively, the shock absorption members 140 may help the support board 120 to be fixed to the external case 130, thereby enhancing assembly convenience greatly. In addition, at least one of the upper end and the lower end of the shock absorption member 140 may be adhered to the first groove 122 or the second groove 134 by adhesive, so that the shock absorption members 140 may be more firmly inserted into the first groove 122 or the second groove 134.

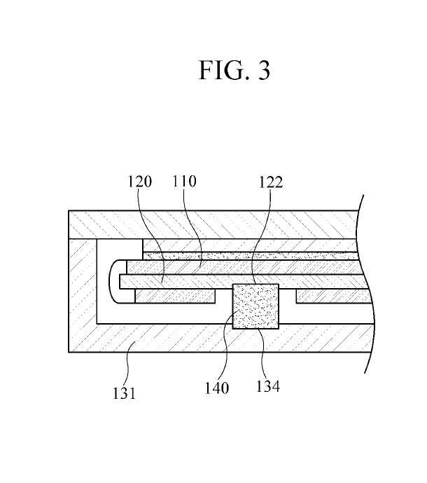

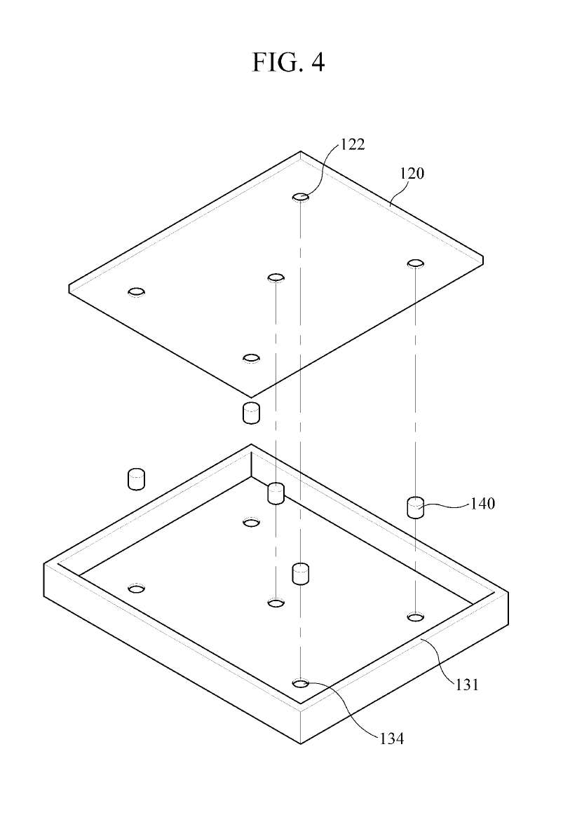

The first grooves 122 may be convex with respect to the protrusions 123 protruding from the bottom surface of the support board 120. In addition, the second grooves 134 may be convex with respect to the protrusions 135 protruding from the inner bottom surface of the external case 130. In another example, as illustrated in FIGS. 3 and 4, the first grooves 122 may be convex on the bottom surface of the support board 120, and the second grooves 134 may be convex on the inner bottom surface of the external case 130. Of course, either the first groove 122 or the second groove 134 may be configured as illustrated in FIG. 2, while the other is configured as shown in FIG. 4.

The first groove 122 and the second groove 134 may have a circular cross-section. In this case, the shock absorption member 140 also has the same circular cross-section as those of the first groove 122 and the second groove 134, so that the upper end and the lower end of the shock absorption member 140 may be inserted into the first groove 122 and the second groove 134, respectively. In this way, the upper end and the lower end of the shock absorption member 140 is able to be more firmly fixed onto the first groove 122 and the second groove 134, respectively.

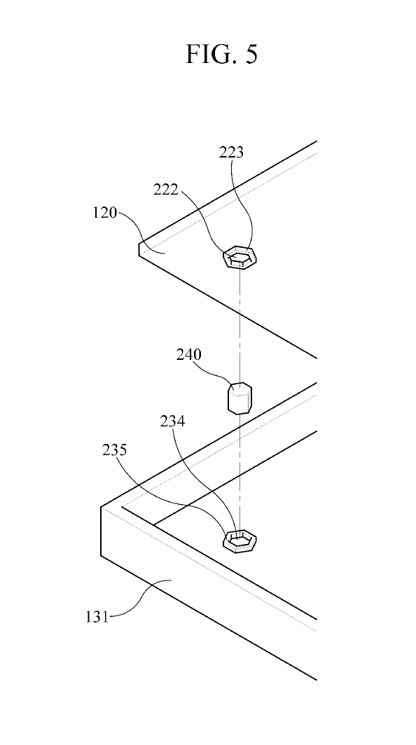

In another example, as illustrated in FIG. 5, the first groove 222 and the second groove 234 may have a polygonal cross-section, for example, a hexagonal cross-section. In this case, a shock absorption member 240 has the same hexagonal cross-section as those of the first groove 222 and the second groove 234, so that the upper end and the lower end of the shock absorption member 240 may be inserted into the first groove 222 and the second groove 234, respectively. In addition, protrusion 223 of the support board 120 and protrusion 235 of the external case 130 may have a hexagonal cross-section.

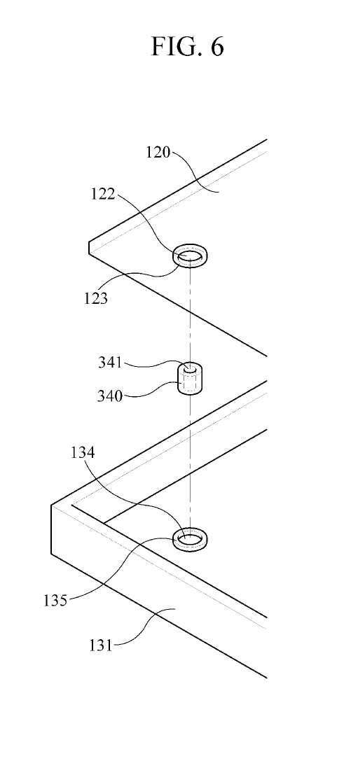

Meanwhile, the shock absorption members 140 and 240 may have a solid shape as illustrated in FIGS. 1 and 5, but a shock absorption member 340 may have a ring shape having a hollow 341 along a vertical direction as illustrated in FIG. 6.

According to an exemplary embodiment of the present invention, a support board may be fixed onto an external case simply by coupling upper ends and lower ends of shock absorption members to the support board and the external case, without screws or locking devices. In addition, the shock absorption members may absorb external force, fragile elements of the X-ray detection array, such as a light converting material layer, a TFT and a glass substrate, may be prevented from damage. In addition, according to an exemplary embodiment of the present invention, a first joining portion and a second joining portion may include grooves which the upper end and the lower end of each shock absorption member are inserted. In this manner, assembly convenience may improve.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A digital X-ray detector comprising:
an X-ray detection array configured to detect an X-ray image when a subject is irradiated with X-ray;
a support board configured to support a lower part of the X-ray detection array and have a bottom surface thereon a plurality of spaced-apart first joining portions are formed;
an external case configured to accommodate the X-ray detection array and the support board and have an inner bottom surface thereon a plurality of second joining portions are formed to correspond to the plurality of first joining portions; and
shock absorption members configured to be vertically arranged between the bottom surface of the support board and the inner bottom surface of the external case, each shock absorption member having an upper end to be coupled to the first joining portion and a lower end to be coupled to the second joining portion.

2. The digital X-ray detector of claim 1, wherein each of the first joining portions comprises a first groove which the upper end of the shock absorption member is inserted into, and each of the second joining portions comprises a second groove which the lower end of the shock absorption member is inserted into.

3. The digital X-ray detector of claim 2, wherein the first grooves are convex with respect to protrusions formed on the bottom surface of the support board, and the second grooves are convex with respect to protrusions formed on the inner bottom surface of the external case.

4. The digital X-ray detector of claim 2, wherein the first grooves are convex on the bottom surface of the support board, and the second grooves are convex on the inner bottom surface of the external case.

5. The digital X-ray detector of claim 2, wherein the first grooves and the second grooves have a circular or polygonal cross-section, and the shock absorption members have a same as a cross-section of the first grooves and the second grooves.

6. The digital X-ray detector of claim 1, wherein the shock absorption members has a ring shape with a hollow which is formed along a vertical direction.

7. The digital X-ray detector of claim 1, further comprising:
a buffer inserted between a top surface of the X-ray detection array and an inner top surface of the external case.
